(19) United States
(12) Patent Application Publication
(10) Pub. No.: US 2004/0021778 A1
(43) Pub. Date: Feb. 5, 2004

(54) Security system with remote access and control

(76) Inventors: Jerome L. Oldani, Sugar Grove, IL (US); Ludko Jelinek, Aurora, IL (US)

Correspondence Address: Mathew R. P. Perrone, Jr., 210 South Main Street, Algonquin, IL, 60102, US

(21) Appl. No.: 10/212,504

(22) Filed: Aug. 5, 2002

(51) Int. Cl. H04N 5/232

(52) U.S. Cl. 348/211.99

(57) ABSTRACT

A security system has at least one security camera structure, with remote control for the positioning and functioning for the lens of the camera at least one security camera structure and with the control preferably being done through the wide area computer service protocol.

This invention relates to a security system and more particularly to security system which allows a user to control one or more cameras from a remote location, especially using a computer supported communication system.

### BACKGROUND OF THE INVENTION

Security systems can allow for the monitoring of remote areas with either a hardwired connection or an INTERNET connection. INTERNET is a trademark identifying a worldwide network of computers, connected over communication lines by an appropriate program, which facilitates transfers of information between computers.

A security system is extremely useful in industrial settings where large areas must be monitored. It is also useful in residential security, where off-site monitoring is essential, especially when the homeowners are absent. Current technology allows an operator to view images from on-site cameras.

However, the current technology does not allow remote control of a camera through an INTERNET connection. Clearly, the purpose of a remote security system, whether industrial or residential, is to monitor the premises. With an ability to adjust the camera, the effectiveness of the camera is greatly increased.

The ability to control security cameras, by allowing the operator to pan, zoom or move the camera's lens is an especially desired feature; since it increases the effectiveness of the security system and decreases the number of cameras needed to patrol an area. Such control of the camera movement permits one camera to do the work of many. No reliable system exists to permit such movement of a camera.

Furthermore, it is also desirable to have such a security camera assembly be self-contained and not require a fixed power source, such as an electrical outlet. For example, an extremely durable battery is especially useful, for it permits placement of the camera without a hard wired power source. With such placement, the camera can be more effective. However, the power consumption of the camera mitigates against such a situation.

Finally, a security system that utilizes motion detectors is very desirable. If the motion detector can be coordinated with the camera and remainder of the security system, great advantages are obtained. Power consumption of the system becomes more efficient. Camera reaction can be more easily directed.

No good system exists to coordinate a motion detector with a remote camera system. It is further difficult to coordinate information from such a complicated system. Without careful coordination, such information may not be used and thus is useless.

### SUMMARY OF THE INVENTION

Among the many objectives of this invention the provision of a security system, which allows for the remote manipulation of a security camera.

A further objective of this invention the provision of a security system with at least one motion sensor input, which in turn facilitates the judicious use of the security systems resources.

Yet a further objective of this invention the provision of a security system utilizing a camera with fine-step motion control.

A still further objective of this invention the provision of a security system utilizing a camera with an optional zoom lens.

Another objective of this invention the provision of a security system is a camera utilizing direct current power, eliminating the need for electrical wiring at the site where the camera is mounted.

Yet another objective of this invention the provision of a security system with a sleep mode, reducing the power consumption of the security system.

Still, another objective of this invention the provision Of a security system with an internal clock, allowing for scheduled monitoring of the facility.

Also, an objective of this invention is the provision of a security system having a coordinated use of information from the security system.

These and other objectives of the invention (which other objectives become clear by consideration of the specification, claims and drawings as a whole) are met by providing a security system having at least one security camera structure, with remote control for the positioning and functioning for the lens of the camera at least one security camera structure and with the control preferably being done through the INTERNET, and the security camera structure itself being substantially self-contained.

### BRIEF DESCRIPTION OF THE DRAWINGS

FIG. 1 depicts a block diagram of a security camera system 100 including a plurality of camera structures 120.

FIG. 2 depicts a pictorial diagram of a security camera system 100 including a plurality of camera structures 120.

FIG. 3 depicts a block diagram of first single camera structure 120.

FIG. 4 depicts a pictorial diagram of first single camera structure 120.

FIG. 5 depicts a perspective view of base housing assembly 140.

FIG. 6 depicts a block diagram of the interconnections within first single camera unit 120.

FIG. 7 depicts a perspective view of vertical gear assembly 184.

FIG. 8 depicts a perspective view of horizontal gear assembly 186.

FIG. 9 depicts a block diagram of a second single camera structure 300.

FIG. 10 depicts a perspective view of lens gear 226 for lens 224.

Throughout the figures of the drawings, where the same part appears in more than one figure of the drawings, the same number is applied thereto.

### DESCRIPTION OF THE PREFERRED EMBODIMENTS

With security camera system of this invention, the adjustable positioning capability of each camera permits that camera to cover a wider range or area. The security camera system includes a plurality of camera structures and a system server.

Each camera structure has a base housing assembly, a gear housing assembly, a camera housing assembly and a power supply. At least one motion detector may also be optionally added to each camera structure. On the base housing assembly is mounted the camera housing assembly, camera control board, the power supply and the gear housing assembly. The gear housing assembly and the camera housing assembly, which are both mounted on the base housing assembly, are interconnected to allow the gear assembly unit to adjust the position of the camera housing assembly.

Mounted in the camera housing assembly is a camera. The camera may be of any suitable type, such as a video camera, a digital camera or other suitable camera. Preferably, the camera is a digital camera.

The camera may have any suitable type of lens, through which the camera may receive images. The camera lens may be motorized or manual. With such control of the lens, the lens may be moved or adjusted from a wide angle view to a telescopic view, a normal view or points in between. Using degrees of the wide angle view or the telescopic view, viewing a wide area, followed by a closeup view is also feasible. For example, the telescopic view can magnify images to any suitable size for a close view of any particular area. Wide angle viewing permits a substantial area to be viewed, with a selected area permitted for closeup viewing by the telescopic view.

The camera also has a digital input and output which is connected to the system server. In a preferred form, the camera is connected to the system server by either an ETHERNET connection and the wireless network card utilizing either 802.11b 2.4Gz or 3G wireless protocol. ETHERNET is a trademark referring to networking cards or cables adapted to connect one computer to another.

The system server is attached to the INTERNET through a modem dial-up connection, cable television connection or a wireless connection, thereby allowing the camera to be controlled by any other computer that has access to the INTERNET. Such a suitable computer may be desktop, a laptop, or a personal data assistant (PDA). Appropriate security protection or security protocols, such as a fire wall, monitor the INTERNET connection to ensure that no unauthorized access to the security system occurs.

Within the gear housing assembly is a camera control board. The camera control board operates both the vertical gear assembly and the horizontal gear assembly, which are also mounted in the gear housing assembly. The connection between the system server and the camera control board permits the horizontal gear assembly and a vertical gear assembly to be operated remotely through an INTERNET connection from any suitable computer to the system server.

Three optional motion detectors preferably may also be connected to each camera control unit or camera structure. One motion detector may be connected to and controlled by the camera itself, whereas the other two motion detectors can be connected to the camera control board.

Any one of these motion detectors, when triggered, sends a signal to the camera control unit. The camera may be programed to aim the camera to the area where the motion was detected and activate the camera to monitor the area of concern. Information from each camera is sent to a remote location, wherein each readout from each camera may be analyzed individually or in combination, and coordinated as desired.

Alternatively, the system can be programmed where the camera or the camera control board relays the detected motion alert to the system server. The system server is programed to dispatch an appropriate response to any and all camera structures in the affected area and notifies the user through or by means of an INTERNET connection with the user's remote computer.

The motion detectors allow the system resources to be conserved by allowing cameras to be shut down when no activity is detected in their monitoring area, and activated when motion is detected. The motion detectors also allow the system to be programmed so adjacent camera units can be synchronized to monitor an area where motion has been detected.

Also connecting the camera control board, camera and lens is the power source. Any suitable power source may be used to provide power to the security camera system. The power source may provide operating power through a hard wired structure. Operating power may also be provided through a self-contained structure. Typical of the self-contained structure, which provide a power source for the security camera system, can include a replaceable or a rechargeable battery.

The most preferred rechargeable battery is a solar powered battery. With a solar battery, each camera structure of the security camera system is automatically recharged during daylight. Thus, such a battery can provide the most reliable and durable service for each camera structure in the security camera system.

With the system server control of each camera structure in the security camera system, additional steps may be taken to preserve battery life even further. The computer of the system server control may time the activation of each camera structure in the camera system on a random or predetermined schedule as desired. Thus, if the camera is not operating all day or night, power is conserved, and the battery lasts longer.

Such a structure for the security camera system is permitted because the camera housing assembly has a substantially three-dimensional movement capability. The camera housing assembly is mounted on the gear housing assembly, which permits a substantially desirable system for a spherical movement of the camera. Such a movement permits a substantial portion of the surface area of a hypothetical sphere to be covered by one camera. In this fashion, the adjacent area relative to the spherical movement can be much larger and covered by this one camera than a camera in other standard positions.

On a standard x-axis, y-axis and z-axis, the camera housing assembly permits rotation within all of the axes. Thus, the camera can be tilted, raised, lowered, or rotated; or have any other desired movement due to the structure of the gear housing assembly. Such movement permits the camera to be directed to and report on a wide area.

With the appropriate INTERNET connection, the positioning of the camera can be accomplished by a remote user of the security system sending a message through the system server to the camera control board. This message provides instruction, which manipulates the three axis rotation system mounted in and permitted by the gear housing assembly. Other messages, including but not limited to power up or power down, may also be sent as desired.

The gear housing assembly moves the camera assembly to a desired position. By adding a motion detector to the system, the camera control board may receive information from the motion detector which results in movement of gears and activation the camera.

By the same token, the system server, however it is activated, may turn the camera on or off, activate the gear box, and utilize recognition software to distinguish between intruders and false alarms. If the camera has a moveable (zoom) lens, the camera control board may be utilized to send lens movement instructions from the system server to the lens. Thus, through the INTERNET connection, the camera lens may be moved by a remote user.

When the power for the camera and the entire rotation system is provided by a solar battery, great advantages are obtained, thereby making a solar, rechargeable battery the preferred power source. More durability and reliability are created. This battery is recharged during the daylight hours, so that the camera may operate all night. The solar rechargeable battery has sufficient power to operate both the camera and the motors, which permit movement of the camera.

When combined with remotely controlled, selective operation times for the camera in the camera housing assembly during the course of a night or other desired watch period, it becomes even more clear that the solar powered battery can last through the selectively required times of use. The camera can be controlled by the computer and operate at randomly selected times.

The security camera system includes a plurality of camera structures. Each camera structure has a base housing assembly, a gear housing assembly, a camera housing assembly and a power supply. The camera structure may be mounted appropriately on a mounting structure.

A mounting structure may be naturally occurring or manmade. The naturally occurring mounting structure include but are not limited to; a tree, a cliff or similar natural structures. Typical of another suitable mounting structure; usually of the man-made type; is at least one selected from the group consisting of a building, a special security pole, a telephone pole, or other item capable of supporting the camera structure and the required accouterments.

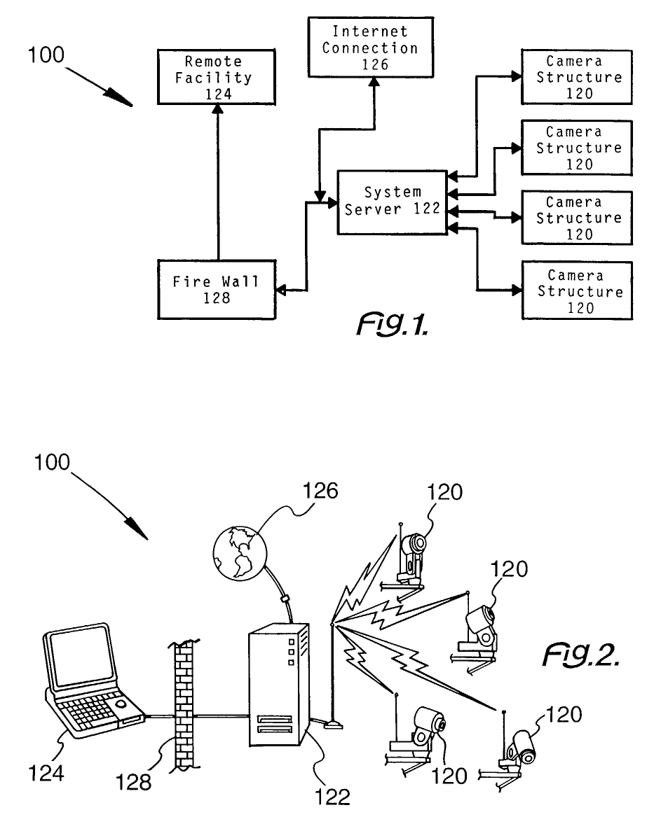

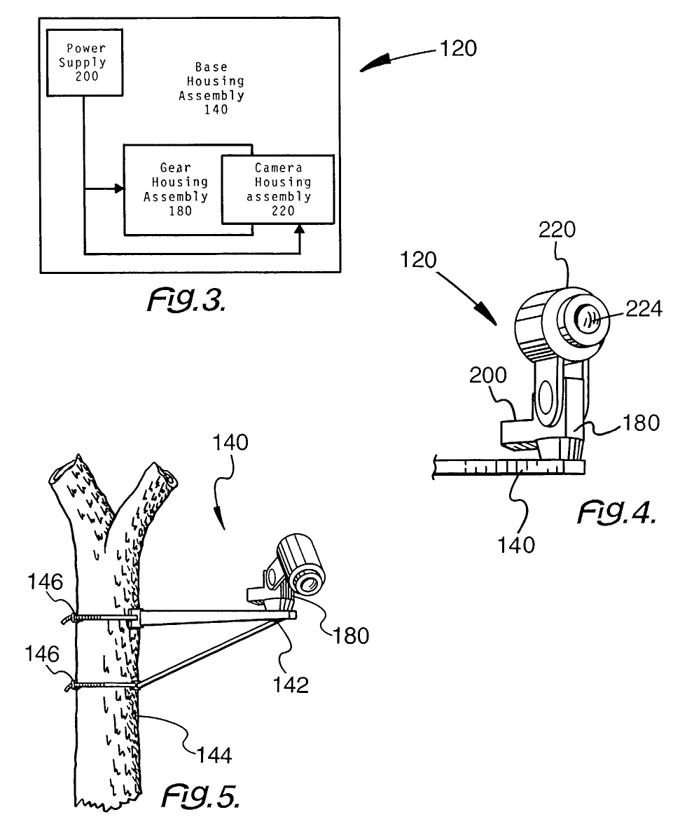

Referring now to FIG. 1 and FIG. 2, security camera system 100 has at least one camera structure 120. Each camera structure 120 of security camera system 100 is connected by either hardware ETHERNET or Wireless connection to a system server 122. The system server 122 has an INTERNET connection which allows the security system 100 to be operated at remote facility 124. The INTERNET connection has the appropriate security protection or a fire wall 128 to prevent unauthorized access.

System server 122 may either provide an analysis of the data collected, provide a proper response thereto or feed remote facility 124 with the data collected so the remote facility 124 can provide a proper response thereto. The response can be triggered manually or by computer, and permit the proper authorities to be dispatched to a desired site.

With the addition of FIG. 3 and FIG. 4 to the discussion, the camera structure 120 becomes more clear. Within each camera structure 120 is a base housing assembly 140, a gear housing assembly 180, power supply 200 and a camera housing assembly 220. On the base housing assembly 140 is mounted the gear housing assembly 180 in a standard fashion. Also, on the base housing assembly 140, is mounted the camera housing assembly 220.

The gear housing assembly 180 cooperates with the base housing assembly 140 and the camera housing assembly 220, in order to provide positioning for camera 222 mounted in camera housing assembly 220.

While the base housing assembly 140 of FIG. 5 may be attached to any suitable structure, a pair of support arms 142 is shown as attached to a tree 144 or other suitable mounting structure. As above set forth, a mounting structure may be naturally occurring or man-made.

On the arm 142 is a standard support 146, which receives the gear housing assembly 180. For example, if the suitable support is on the top of a pole (not shown), camera 222 may cover at least almost the entire surface area of a sphere, roughly defined with great efficiency. With tree 144 as support for the base housing assembly 140, concealment of the presence of camera 222 is more feasible, but surface covered is usually not as complete.

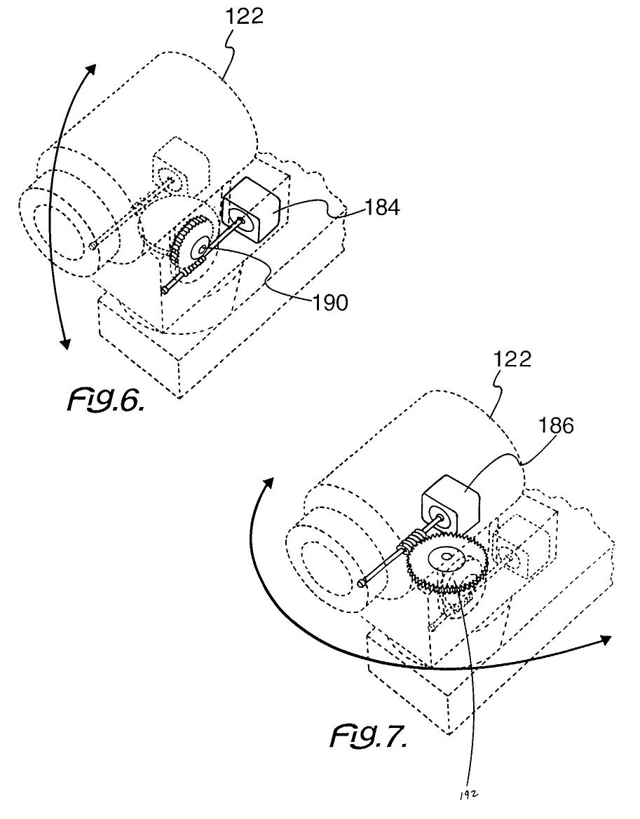

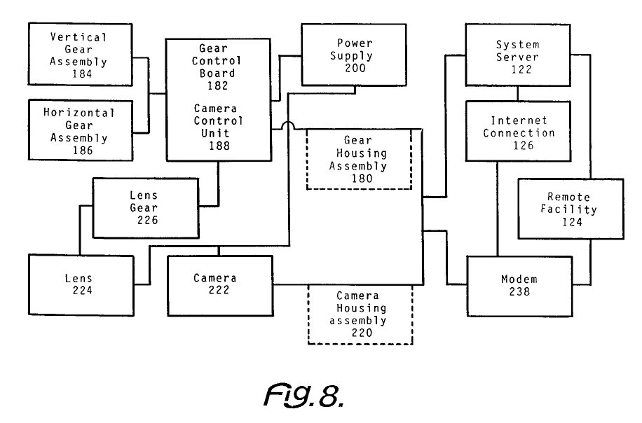

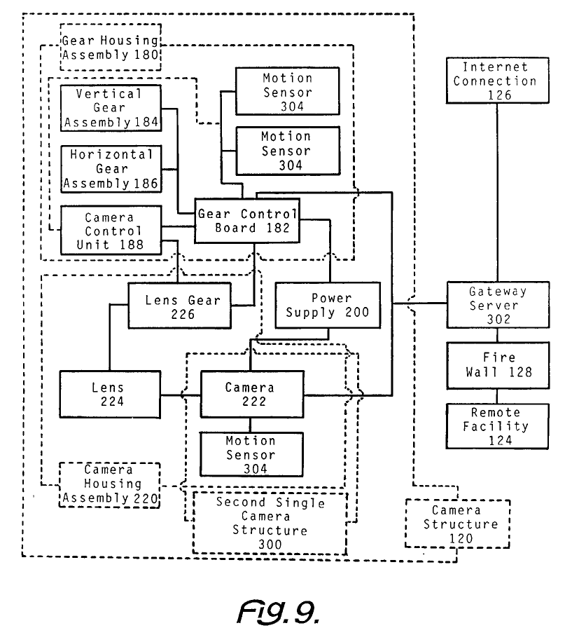

With FIG. 6, one operating mode for vertical gear assembly 184 is shown as vertical worm gear 190, although other vertical moving devices are operable. Thus, camera 222 may be moved vertically in a wide arc. By the same token, with FIG. 7, horizontal gear assembly 186 is controlled with one option shown as horizontal worm gear assembly 192, although other horizontal moving devices are operable. Horizontal worm gear 192 permits a wide horizontal arc. The combination therebetween provides camera 222 with the ability to move in substantially spherical arc and cover a wider area.

As shown in FIG. 8, within gear housing assembly 180 is camera control board 182. The camera control board 182 operates both the vertical gear assembly 184 and the horizontal gear assembly 186, which are also mounted in the gear housing assembly 180.

With the cooperative or separate gear operation of the vertical gear assembly 184 and the horizontal gear assembly 186, camera housing assembly may be pointed at a variety of directions. When this gear operation is jointly or severally operated as desired pursuant to instructions sent from the camera control board 182.

The camera control board 182 is connected to the camera control unit 188. The camera control unit 188 has either an ETHERNET or wireless connection to the system server 122. From the system server 122 or from a remote connection through the INTERNET connection 126, instructions may be passed through the camera control unit 188 to the gear control board 182 to allow remote control of either one or both of vertical gear assembly 184 or horizontal gear assembly 186.

The camera control board 182 is also connected to the system server 122. In a preferred form, the camera control board 182 is connected to the system server by either an ETHERNET connection and the wireless network card utilizing either 802.11b 2.4Gz or 3G wireless protocol. Power supply 200 is connected to the gear control board 182, camera control unit 188, vertical gear assembly 184, and horizontal gear assembly 186, and camera 222.

The camera housing assembly 220 is secured to the gear housing assembly 180. Preferably, the camera housing assembly 220 is mounted on the base housing assembly 140 (FIG. 5). Through the gear housing assembly 180, base housing assembly 140 (FIG. 5) and, hence, camera housing assembly 220 may be moved.

Within the camera housing assembly 220 is mounted a camera 222. The camera 222 has mounted therein a lens 224 and a lens gear 226. Lens 224 may be adjusted in any suitable fashion, such telescopic or wide angle, in order to increase the efficiency of camera 222. Camera 222 receives input from the control board 182 through power source 200. Such input includes instructions to power up, shut off and move the lens 224. Thus, lens 224 can be controlled by a remote user through an INTERNET connection 126 to the system server 122, or remote facility 124 through the ETHERNET or a wireless connection to the camera control board. The camera lens 224 may be adjusted from telescopic to wide angle as desired.

Camera 222 also sends its digital output of the images it captures to the camera control unit 188. The camera control unit 188 relays the output through its wireless or camera ETHERNET connection 126 through remote facility 124 to the system server 122 (FIG. 1), through the INTERNET connection 126 to the remote facility 124. Camera 222 is also connected to a modem 238, which modem 238 is also connected to outside computer 234.

In FIG. 9, a plurality of second single camera structure 300 may also be incorporated into FIG. 1. Second single camera structure 300 may be used alone or in combination with at least one second single camera structure 300 or with at least one first single camera structure 120.

Second single camera structure 300 includes system server system 302 which is connected to a camera structure 120 and gear housing assembly 180. A power supply 200 feeds to both camera housing assembly 220 and gear housing assembly 180. Additionally, there is a direct connection on power supply 200 to camera 222. Camera 222 is connected to a motion detector 304. Motion detector 304 is also connected to the camera control unit 188.

The system server 302 has an INTERNET connection 126 to the remote user. Appropriate security checks or firewalls may be placed on the INTERNET connection 126 between the system server 302 and the remote user. Clearly, security camera system 100 may include first camera structure 120 from FIG. 3, second camera structure 300, or combinations thereof.

Motion detector 304 may be used to increase the efficiency of camera structure 300. Motion detectors 304 allow the system to divert camera resources from non-active areas of the facility and concentrate the monitoring of areas where activity is taking place.

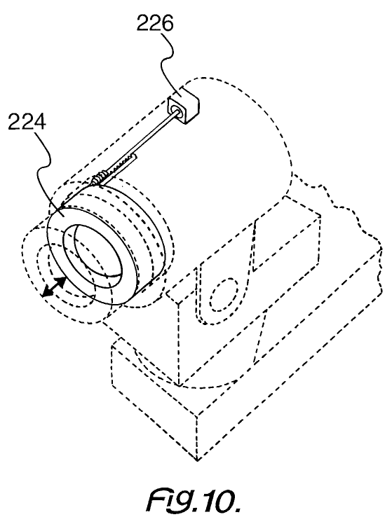

With the additional consideration of FIG. 10, lens gear 226 is basically a worm gear adapted to cooperate with lens 224 and provide adjustments, such as a wide angle view or a telescopic view therefor. Any other type of gearing system for lens gear 226 may be used so long as it may be remotely operated within the terms of this structure. Such operation is accomplished through a wireless or wired setup.

This application; taken as a whole with the abstract, specification, claims, and drawings being combined; provides sufficient information for a person having ordinary skill in the art to practice the invention as disclosed and claimed herein. Any measures necessary to practice this invention are well within the skill of a person having ordinary skill in this art after that person has made a careful study of this disclosure.

Because of this disclosure and solely because of this disclosure, modification of this method and device can become clear to a person having ordinary skill in this particular art. Such modifications are clearly covered by this disclosure.

What is claimed and sought to be protected by Letters Patent of the United States is:

1. A security system having at least one security camera structure, comprising:
(a) the at least one security camera structure having a camera housing assembly with a camera, a positioning means and a lens control means mounted therein;
(b) the positioning means including a horizontal positioning means and a vertical positioning means;
(c) the horizontal positioning means and the vertical positioning means cooperating to move the camera to a number of desired positions;
(d) the lens control means providing at least a wide angle view, a telescopic view, and a normal view; and
(e) a means for receiving and analyzing information from the at least one security camera structure.

2. The security system of claim 1 further comprising:
(a) a self-contained power source for the at least one security camera structure;
(b) the at least one security camera structure having a base housing assembly connected to the camera housing assembly through a gear housing assembly; and
(c) the gear housing assembly providing a range for the camera.

3. The security system of claim 1 further comprising:
(a) the at least one security camera structure having a base housing assembly connected to the camera housing assembly through a gear housing assembly;
(b) the base housing assembly being securable to a desired support; and
(c) the gear housing assembly providing a range of movement for the camera.

4. The security system of claim 3 further comprising:
(a) at least one motion detector cooperating with the security camera structure;
(b) the at least one motion detector providing an activation means for the camera; and
(c) a remote control means being to operate the camera.

5. The security system of claim 4 further comprising:
(a) the camera being selected from the group consisting of a video camera and a digital camera;
(b) the camera having an adjustable lens;
(c) the camera having a digital input and output connected to a system server for the security system; and
(d) the system server providing control of positioning and viewing for the camera.

6. The security system of claim 5 further comprising:
(a) a security protocol protecting the security system;
(b) a camera control board in the gear housing assembly operating both the vertical gear assembly and the horizontal gear assembly;
(c) the camera control board operating the vertical gear assembly and the horizontal gear assembly in a joint fashion or a separate fashion;
(d) the joint fashion providing a substantial range for the adjustable lens; and
(e) a remote connection operating the camera and the gear assembly.

7. The security system of claim 6 further comprising:
(a) the remote connection being at least one selected from the group consisting of an internet connection, a modem connection, a wired computer connection, and a wireless computer connection; and
(b) a security mechanism between the security system and the remote connection.

8. The security system of claim 7 further comprising:
(a) at least one motion detector being connected to the camera structure;
(b) the at least one motion detector serving to activate the camera;
(c) the at least one motion detector providing aiming information to the camera; and
(d) the remote connection operating adjustable lens.

9. The security system of claim 8 further comprising:
(a) the at least one motion detector being a first motion detector, a second motion detector and a third motion detector;
(b) the first motion detector being connected to and controlled by the camera;
(c) the second motion detector and the third motion detector being connected to the camera control board in order to send a signal to the camera control unit and activate a programmed movement of the camera; and
(d) a remote receiving means being connected to the camera and providing a readout from the camera.

10. The security system of claim 9 further comprising:
(a) the at least one motion detector conserving energy by selectively activating the camera as motion is detected; and
(b) the at least one motion detector conserving energy by selectively allowing the camera to be shut down as motion is absent; and
(c) a synchronizing means cooperating with the at least one motion detector to permit cooperation between at least a first camera and a second camera of the security system; and
(d) a readout analyzing at least the second camera and the first camera.

11. The security system of claim 10 further comprising:
(a) a power source connecting the camera control board, the camera and the lens;
(b) a system server control providing cooperation of at least the first camera and the second camera; and
(c) a system server control providing control of the activation of at least the first camera and the second camera in the camera system on a random or predetermined schedule.

12. The security system of claim 11 further comprising:
(a) the vertical gear assembly and the horizontal gear assembly cooperating to provide a substantially three-dimensional movement capability for the camera;
(b) the camera housing assembly being mounted on the gear housing assembly; and
(c) at least the first camera and the second camera being directed by a wireless connection.

13. The security system of claim 12 further comprising:
(a) the power source being a solar, rechargeable battery;
(b) the vertical gear assembly being a first worm gear;
(c) the horizontal gear assembly being a second worm gear; and
(c) the lens control including a third worm gear.

14. A security camera structure, comprising:
(a) a camera housing assembly with a camera, a positioning means and a lens control means mounted therein;
(b) the positioning means including a horizontal positioning means and a vertical positioning means;
(c) the horizontal positioning means and the vertical positioning means cooperating to move the camera to a number of desired positions;
(d) the lens control means providing a least a wide angle view, a telescopic view, and a normal view;
(e) a self-contained power source for the at least one security camera structure;
(f) the at least one security camera structure having a base housing assembly connected to the camera housing assembly through a gear housing assembly; and
(g) the gear housing assembly providing a range for the camera.

15. The security camera structure of claim 14 further comprising:
(a) the at least one security camera structure having a base housing assembly connected to the camera housing assembly through a gear housing assembly;
(b) the base housing assembly being securable to a desired support;
(c) the camera being selected from the group consisting of a video camera and a digital camera;
(d) the camera having an adjustable lens;
(e) the camera having a digital input and output connected to a system server for the security system; and
(e) the system server providing control of positioning and viewing for the camera.

16. The security camera structure of claim 15 further comprising:
(a) a security protocol protecting the security system;
(b) a camera control board in the gear housing assembly operating both the vertical gear assembly and the horizontal gear assembly;
(c) the camera control board operating the vertical gear assembly and the horizontal gear assembly in a joint fashion or a separate fashion;
(d) the joint fashion providing a substantial range for the adjustable lens;
(e) a remote connection operating the camera and the gear assembly; and
(f) a motion detector conserving energy by selectively allowing the camera to be shut down as motion is absent.

17. The security camera structure of claim 16 further comprising:
(a) a power source connecting the camera control board, the camera and the lens;
(b) the vertical gear assembly and the horizontal gear assembly cooperating to provide a substantially three-dimensional movement capability for the camera; and
(c) the camera housing assembly being mounted on the gear housing assembly.

18. The security camera structure of claim 17 further comprising:
(a) the power source being a solar, rechargeable battery;
(b) the vertical gear assembly being a first worm gear;
(c) the horizontal gear assembly being a second worm gear; and
(c) the lens control including a third worm gear.

19. A method of providing a security system having at least one security camera structure, comprising:
(a) providing at least one security camera structure with a camera housing assembly with a camera, a positioning means and a lens control means mounted therein;
(b) mounting at least first member of the at least one security camera structure in a first desired position;
(c) activating the camera at a desired time in order to provide an activated camera;
(d) positioning the activated camera to cover substantially most of a spherical perimeter;
(e) providing at least one image from the activated camera to a remote site;
(f) analyzing the at least one image in order to make an appropriate response; and
(g) making an appropriate response.

20. The method of claim 19 further comprising:
(a) providing a renewable, self-contained power source for the at least one security camera structure;
(b) providing a lens control means for the camera in order to provide at least a wide angle view, a telescopic view, and a normal view;
(c) providing a sufficient number of the at least one security camera structure to cover a desired area;
(d) providing at least one motion detector to cooperate with the at least on security camera structure and provide an activation means for the camera;
(e) operating the at least one security camera structure from a remote site;
(f) providing a digital input and output connected to a system server for a security system formed from the at least one security camera structure; and
(g) providing a security protocol in order to protect the security system.
